(19) United States
(12) Patent Application Publication
(10) Pub. No.: US 2022/0070909 A1
(43) Pub. Date: Mar. 3, 2022

(54) TERMINAL AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Lihui Wang, Beijing (CN); Shaozhen Guo, Beijing (CN)

(73) Assignee: NTT DOCOMO, INC., Tokyo (JP)

(21) Appl. No.: 17/312,179

(22) PCT Filed: Dec. 11, 2018
(86) PCT No.: PCT/JP2018/045521

§ 371 Date: Jun. 9, 2021

(51) Int. Cl. H04W 72/12

(52) U.S. Cl. CPC H04W 72/1289

(57) ABSTRACT

A user terminal includes: a control section that controls monitoring of one search space set or a plurality of search space sets associated with a plurality of control resource sets; and a receiving section that receives downlink control information that is mapped on a downlink control channel candidate included in the one search space set or a plurality of downlink control channel candidates respectively included in the plurality of search space sets.

### TECHNICAL FIELD

The present disclosure relates to a user terminal and a radio communication method of a next-generation mobile communication system.

### BACKGROUND ART

In Universal Mobile Telecommunications System (UMTS) networks, for the purpose of higher data rates and lower latency, Long Term Evolution (LTE) has been specified (Non-Patent Literature 1). Furthermore, for the purpose of a larger capacity and higher sophistication than those of LTE (Third Generation Partnership Project (3GPP) Releases (Rel.) 8 and 9), LTE-Advanced (3GPP Rel. 10 to 14) has been specified.

LTE successor systems (also referred to as, for example, the 5th generation mobile communication system (5G), SG+ (plus), New Radio (NR) or 3GPP Rel. 15 or subsequent releases) are also studied.

In legacy LTE systems (e.g., 3GPP Rel. 8 to 14), a user terminal (User Equipment (UE)) monitors a downlink control channel (e.g., Physical Downlink Control Channel (PDCCH)), and controls reception of a downlink shared channel (e.g., Physical Downlink Shared Channel (PDSCH)) or transmission of an uplink shared channel (e.g., Physical Uplink Shared Channel (PUSCH)) based on detected Downlink Control Information (DCI).

DCI used to schedule a PDSCH is also referred to as, for example, a Downlink (DL) assignment, and DCI used to schedule a PUSCH is also referred to as, for example, an Uplink (UL) grant.

### CITATION LIST

### Non-Patent Literature

Non-Patent Literature 1: 3GPP IS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

It is studied for a future radio communication system (also referred to as NR below) to convey a downlink control channel (e.g., PDCCH) that uses a COntrol REsource SET (CORESET) configured to a UE to improve frequency domain resource use efficiency.

Furthermore, it is also studied for NR to provide a service (e.g., Ultra Reliable and Low Latency Communications (URLLC)) for which at least one of ultra reliability and low latency is requested compared to, for example, a service of a high speed and a large volume (enhanced Mobile Broad Band (eMBB)). Hence, a new structure of a downlink control channel that is suitable to the service is preferred.

It is therefore one of objects of the present disclosure to provide a user terminal and a radio communication method that can use a downlink control channel that is suitable to a service (e.g., URLLC) for which at least one of ultra reliability and low latency is requested.

### Solution to Problem

A user terminal according to one aspect of the present disclosure includes: a control section that controls monitoring of one search space set or a plurality of search space sets associated with a plurality of control resource sets; and a receiving section that receives downlink control information that is mapped on a downlink control channel candidate included in the one search space set or a plurality of downlink control channel candidates respectively included in the plurality of search space sets.

### Advantageous Effects of Invention

According to one aspect of the present disclosure, it is possible to use a downlink control channel that is suitable to a service (e.g., URLLC) for which at least one of ultra reliability and low latency is requested.

### BRIEF DESCRIPTION OF DRAWINGS

FIG. 1 is a diagram illustrating one example of a PDCCH structure according to the present embodiment.

FIG. 2 is a diagram illustrating one example of a PDCCH structure according to a first aspect.

FIGS. 3A to 3C are diagrams illustrating one examples of a relation between portion domains and CORESETs according to the first aspect.

FIG. 4 is a diagram illustrating one example of a PDCCH structure according to a second aspect.

FIGS. 5A to 5C are diagrams illustrating one examples of a relation between DCI, SS sets and CORESETs according to the second aspect.

FIG. 6 is a diagram illustrating one example of a schematic configuration of a radio communication system according to one embodiment.

FIG. 7 is a diagram illustrating one example of a configuration of a base station according to the one embodiment.

FIG. 8 is a diagram illustrating one example of a configuration of a user terminal according to the one embodiment.

FIG. 9 is a diagram illustrating one example of hardware configurations of the base station and the user terminal according to the one embodiment.

### DESCRIPTION OF EMBODIMENTS

It is studied for NR to use a COntrol REsource SET (CORESET) to transmit a control signal of a physical layer (e.g., DCI) from a base station to a UE.

The CORESET is a downlink control channel (e.g., Physical Downlink Control Channel (PDCCH)) allocation candidate domain. The CORESET may be configured to include a given frequency domain resource (e.g., 1 or more Physical Resource Blocks (PRBs)) and time domain resource (e.g., 1 or more symbols).

A PDCCH (or DCI) may be mapped on a candidate resource (also referred to as, for example, a PDCCH candidate or a downlink control channel candidate) in a CORESET. For example, the PDCCH (or the DCI) may be mapped on a PDCCH candidate in a search space (a Search Space (SS) set including one or more search spaces associated with the CORESET.

The SS set is also referred to as, for example, a search space set or a PDCCH search space set or simply as a search space. The SS set may include a search space per aggregation level.

The PDCCH candidate may include at least one of, for example, given resource units (e.g., Control Channel Elements (CCEs), CCE groups including one or more CCEs, Resource Element Groups (REGs) including one or more Resource Elements (REs), REG bundles (REG groups) or PRBs).

One PDCCH candidate may be configured by aggregating the above given resource units the number of which corresponds to an aggregation level. At, for example, aggregation level 4, one PDCCH candidate may be configured by aggregating four resource units (e.g., CCEs). In addition, the aggregation level is not limited to 4, and, for example, 1, 2, 8, 16 and 32 may be used therefor.

The UE monitors (blind-decodes) PDCCH candidate sets in one or more CORESETs. For example, the UE may monitor an SS set (or one or more PDCCH candidates in the SS) configured to the UE, and detect DCI for the user terminal. In this regard, monitoring may refer to decoding each PDCCH candidate according to a DCI format to be monitored.

The SS set may include an SS set (Common Search Space (CSS) set) that is used to monitor DCI that is common (cell-specific) between one or more UEs, and an SS set (UE-specific Search Space (USS) set) that is used to monitor UE-specific DCI.

A given number S (e.g., S is 10 or less) of SS sets may be configured to the LE per downlink partial bandwidth (Bandwidth Part (BWP)) in a serving cell. Configuration information (e.g., higher layer parameter “SearchSpace”) of each SS set may give at least one of following parameters to the UE:
An index s (e.g., higher layer parameter “searchSpaceId”) of the SS set.
An association between an SS set #s and a CORESET #p (e.g., higher layer parameter “controlResourceSetId”).
A PDCCH monitoring periodicity of a given slot and a PDCCH monitoring offset of the given slot (e.g., higher layer parameter “monitoringSlotPeriodicityAndOffset”).
A PDCCH monitoring pattern (e.g., higher layer parameter “monitoringSymbolsWithinSlot”) that indicates a symbol to be monitored in a slot configured for PDCCH monitoring.
The number of PDCCH candidates per aggregation level.
Which one of a CSS set and a USS set the SS set #s is (e.g., higher layer parameter “searchSpaceType”).
Information that indicates which DCI format to use to monitor PDCCH candidates.

The UE may determine a PDCCH monitoring occasion for the SS set #s in the CORESET #p based on at least one of the PDCCH monitoring periodicity, the PDCCH monitoring offset and the PDCCH monitoring pattern in a slot configured by the above parameters.

Thus, it is assumed for NR that one DCI is mapped in one CORESET. More specifically, one DCI may be mapped on one PDCCH candidate in one SS set, and the PDCCH candidate may be mapped in one CORESET associated with the SS set.

By the way, it is studied for NR to provide a service (e.g., Ultra Reliable and Low Latency Communications (URLLC)) for which ultra reliability and low latency are requested compared to, for example, a service of a high speed and a large volume (enhanced Mobile Broad Band (eMBB)).

For example, followings are studied as a PDCCH structure that can realize at least one of ultra reliability and low latency requested for URLLC, for example:
(1) A relatively large Aggregation Level (AL) is used for the PDCCH (e.g., AL 8 or AL 16).
(2) Precoder cycling (soft combining) is used for the PDCCH (e.g., AL 4×2 with precoder cycling (soft combining) or AL 8×2 with precoder cycling (soft combining)).
(3) Precoder cycling (selection) is used for the PDCCH (e.g., AL 4×2 with precoder cycling (selection) or AL 8×2 with precoder cycling (selection)).

However, when a probability (also referred to as, for example, a blocking probability or a blockage) that a plurality of pieces of DCI are mapped on the same PDCCH candidate is not taken into account, there is a risk that above (2) does not contribute to received quality (e.g., Signal-to-Noise Ratio (SNR)) of the pieces of DCI.

Hence, a new PDCCH structure that can realize at least one of ultra reliability and low latency is preferred. Hence, the inventors of the present disclosure have conceived that it is possible to satisfy at least one of ultra reliability and low latency requested for URLLC, for example, by mapping one DCI across a plurality of CORESETs.

An embodiment according to the present disclosure will be described in detail below with reference to the drawings. A configuration described in each embodiment may be each applied alone or may be applied in combination.

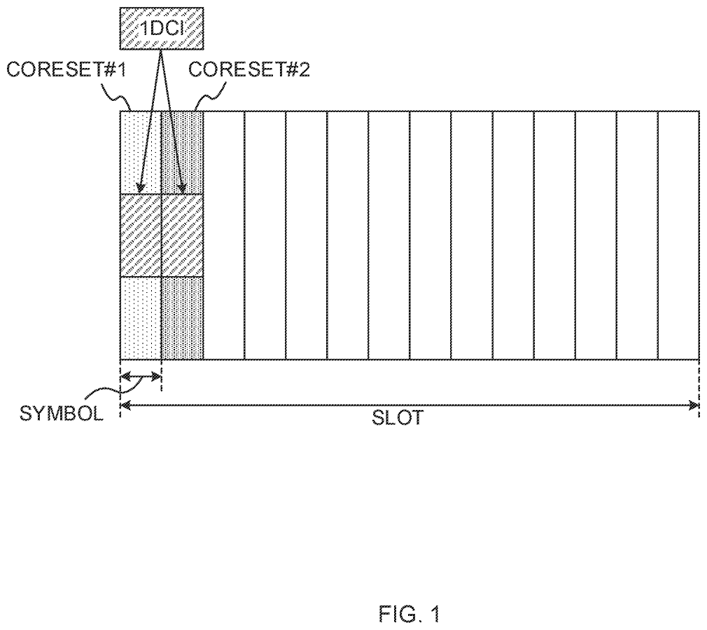

FIG. 1 is a diagram illustrating one example of a PDCCH structure according to the present embodiment. FIG. 1 illustrates the one example where a plurality of CORESETs are configured to different symbols in a slot. For example, in FIG. 1, CORESETs #1 and #2 are configured to first and second symbols in the slot.

In addition, positions of a plurality of CORESETs in the slot are not limited to those illustrated in FIG. 1. At least ones of time domain resources (e.g., symbols) and frequency domain resources (e.g., PRBs) of a plurality of these CORESETs only need to be configured to different positions. Furthermore, a plurality of these CORESETs may be arranged in one or more slots or may partially overlap.

As illustrated in FIG. 1, one DCI may be mapped across a plurality of CORESETs. For example, in FIG. 1, one DCI is mapped on given resource units in the CORESETs #1 and #2 in the slot.

The given resource units only need to be, for example, one or more CCEs, one or more CCE groups, one or more REGs, one or more REG bundles or one or more PRBs.

As illustrated in FIG. 1, by mapping the one ICI across a plurality of CORESETs, it is possible to improve received quality of the one DCI in the UE. As a result, it is possible to satisfy at least one of ultra reliability and low latency requested for URLLC, for example.

Thus, in a case where one DCI is mapped across a plurality of CORESETs, there are conceived a method (first aspect) for mapping the one DCI in one SS set associated with a plurality of these CORESETs, and a method (second aspect) for mapping the one DCI in a plurality of SS sets respectively associated with a plurality of these CORESETs.

### FIRST ASPECT

According to the first aspect, DCI may be mapped in one SS set associated with a plurality of CORESETs.

More specifically, a UE may monitor the one SS set associated with a plurality of these CORESETs, and receive (detect) the DCI that is mapped on one PDCCH candidate in the one SS set.

The one PDCCH candidate may be divided (split) into a plurality of portion domains. A plurality of these portion domains may be associated with a plurality of respectively different CORESETs.

One PDCCH candidate may be mapped on a plurality of CORESETs equally between a plurality of these CORESETs, or based on at least one of a resource size and the number of symbols of each CORESET. For example, one or a combination of at least two of following (1) to (4) may be used as at least part of a rule.

(1) Equal distribution (In a case where, for example, one PDCCH candidate is associated with two CORESETs, half of CCEs or REGs that make up the PDCCH candidate are mapped on a first CORESET, and other half are mapped on a second CORESET).

(2) Distribution in proportion to resource sizes of CORESETs (In a case where, for example, one PDCCH candidate is associated with two CORESETs, when resource sizes of the first CORESET and the second CORESET are the same, half of CCEs or REGs that make up the PDCCH candidate are mapped on the first CORESET, and other half are mapped on the second CORESET. When the resource size of the first CORESET is half the resource size of the second CORESET, one third of the CCEs or the REGs that make up the PDCCH candidate are mapped on the first CORESET, and remaining two thirds are mapped on the second CORESET).

(3) Distribution in proportion to the numbers of symbols of CORESETs (In a case where, for example, one PDCCH candidate is associated with two CORESETs, when the numbers of symbols of the first CORESET and the second CORESET are the same, half of CCEs or REGs that make up the PDCCH candidate are mapped on the first CORESET, and other half are mapped on the second CORESET. When the first CORESET includes 1 symbol and the second CORESET includes 2 symbols, one third of the CCEs or the REGs that make up the PDCCH candidate are mapped on the first CORESET, and remaining two thirds are mapped on the second CORESET).

(4) Distribution in inverse proportion to the numbers of symbols of CORESETs (In a case where, for example, one PDCCH candidate is associated with two CORESETs, when the numbers of symbols of the first CORESET and the second CORESET are the same, half of CCEs or REGs that make up the PDCCH candidate are mapped on the first CORESET, and other half are mapped on the second CORESET. When the first CORESET includes 1 symbol and the second CORESET includes 2 symbols, two thirds of the CCEs or the REGs that make up the PDCCH candidate are mapped on the first CORESET, and remaining one third are mapped on the second CORESET).

A smallest size of each portion domain is, for example, 2, 3 or 6 REGs, yet is not limited to these. Each portion domain may be configured in any resource units such as CCEs, CCE groups, REGs, REG bundles or PRBs, and the number of resource units that make up each portion domain only needs to be one or more.

Precoders may be different between a plurality of portion domains that make up one PDCCH candidate. That is, different precoding weights (beams) may be applied between a plurality of these portion domains.

Furthermore, a plurality of portion domains that make up one PDCCH candidate are associated with different CORESETs, and therefore states of different Transmission Configuration Indications (Transmission Configuration Indicators (TCIs)) (TCI states) may be applied to a plurality of these portion domains.

In this regard, the TCI state may indicate a relation of Quasi-Co-Location (QCL) (QCL relation) of at least one of a channel and a signal (channel/signal). For example, the TCI state may indicate a QCL relation between a Demodulation Reference Signal (DMRS) of a PDCCH and a downlink reference signal.

QCL is an index that indicates a statistical property of at least one of a channel and a signal (channel/signal). When, for example, a certain channel/signal and another channel/signal have a QCL relation, the QCL relation may mean that it is possible to assume that at least one of a Doppler shift, a Doppler spread, an average delay, a delay spread and a spatial parameter (e.g., spatial reception parameter (spatial Rx parameter)) is identical (the QCL holds for at least one of these parameters) between a plurality of these different channels/signals.

The downlink reference signal that has the QCL relation with the DMRS of the PDCCH may be a Synchronization Signal Block (SSB) or a Channel State information Reference Signal (CSI-RS). In this regard, the SSB is a block (resource) including a synchronization signal and a broadcast channel (Physical Broadcast Channel (PBCH)), and is also referred to as, for example, an SS/PBCH block.

In addition, the TCI state may indicate a QCL relation between a DMRS of a PDCCH and a downlink reference signal resource. The downlink reference signal resource may be an SSB or a CSI-RS resource (non-zero power CSI-RS resource).

The UE may control reception processing (e.g., at least one of reception, demapping, demodulation and decoding) of a partial domain associated with each of a plurality of these CORESETs based on a TCI state configured to each of a plurality of these CORESETs.

Furthermore, when a plurality of TCI states are configured to each CORESET, a Medium Access Control Control Element (MAC Control Element (MAC CE)) may indicate one of a plurality of these TCI states. In this case, the UE may control the reception processing of the partial domain associated with each CORESET based on the TCI state indicated by the MAC CE.

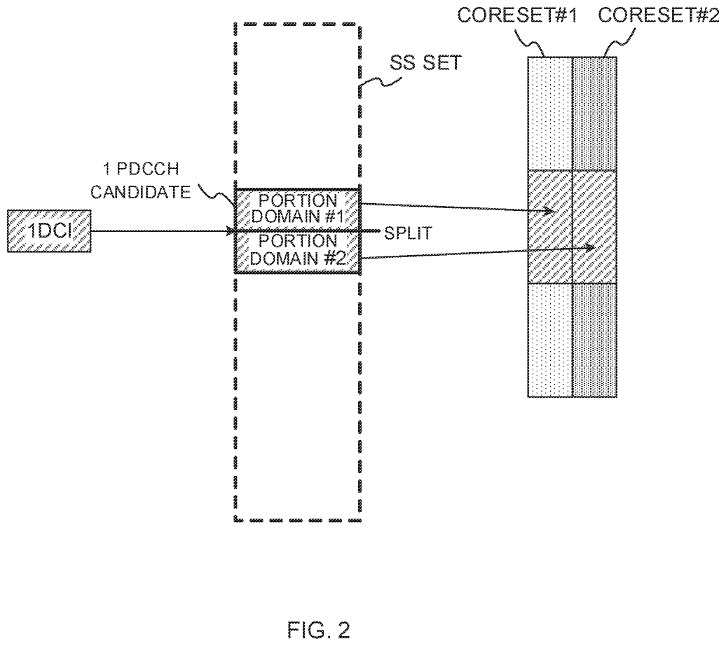

FIG. 2 is a diagram illustrating one example of a PDCCH structure according to the first aspect. A relation between one DCI and one SS set and a relation between one SS set and a plurality of CORESETs will be mainly described with reference to FIG. 2 on the premise of FIG. 1.

In addition, FIG. 2 illustrates one example where one DCI is mapped on two CORESETs. However, the number of CORESETs on which the one DCI is mapped may be 2 or more. Similarly, the number of portion domains obtained by splitting one PDCCH candidate may be 2 or more.

As illustrated in FIG. 2, the one DCI may be mapped on the one PDCCH candidate in the one SS set. For example, in FIG. 2, the one PDCCH candidate is split into two portion domains #1 and #2. The portion domains #1 and #2 are associated with a plurality of respectively different CORESETs according to a given rule. In addition, in FIG. 2, the portion domains #1 and #2 are associated with CORESETs #1 and #2, respectively. However, an association between portion domains and CORESETs is not limited to that illustrated in FIG. 2 as described below.

In addition, the portion domains and the CORESETs are associated on a one-to-one basis in FIG. 2. However, the association is not limited to this. One PDCCH candidate may be split into portion domains the number of which is larger than the number of CORESETs on which DCI is mapped. In this case, one or more portion domains may be associated with each CORESET.

Furthermore, the number of portion domains that make up one PDCCH candidate may be determined based on an Aggregation Level (AL) of the PDCCH candidate. In a case of, for example, AL 2, one PDCCH candidate may be split into two portion domains. Thus, one PDCCH candidate may be split into portion domains the number of which is equal to an AL (i.e., the number of CCEs that make up the one PDCCH candidate), and each portion domain may include 1 CCE.

In addition, as described above, each portion domain may be configured in any resource units such as CCEs, CCE groups, REGs, REG bundles or PRBs. Furthermore, the number of resource units (e.g., CCEs, CCE groups, REGs, REG bundles or PRBs) that make up each portion domain also only needs to be one or more. For example, the portion domains #1 and #2 may each include, for example, 2, 3 or 6 REGs. Furthermore, all of sizes of respective portion domains that make up one PDCCH candidate may be identical, or at least part of the sizes may be different.

Furthermore, in FIG. 2, precoders may be different between the portion domains #1 and #2 that make up the one PDCCH candidate. For example, in FIG. 2, the UE may control reception processing of the portion domains #1 and #2 associated with the CORESETs #1 and #2, respectively, based on respectively configured TCI states of the CORESETs #1 and #2.

### Association Between Portion Domains and CORESETs

Hereinafter, an association between each portion domain and each CORESET that make up each PDCCH candidate in an SS set will be described in detail.

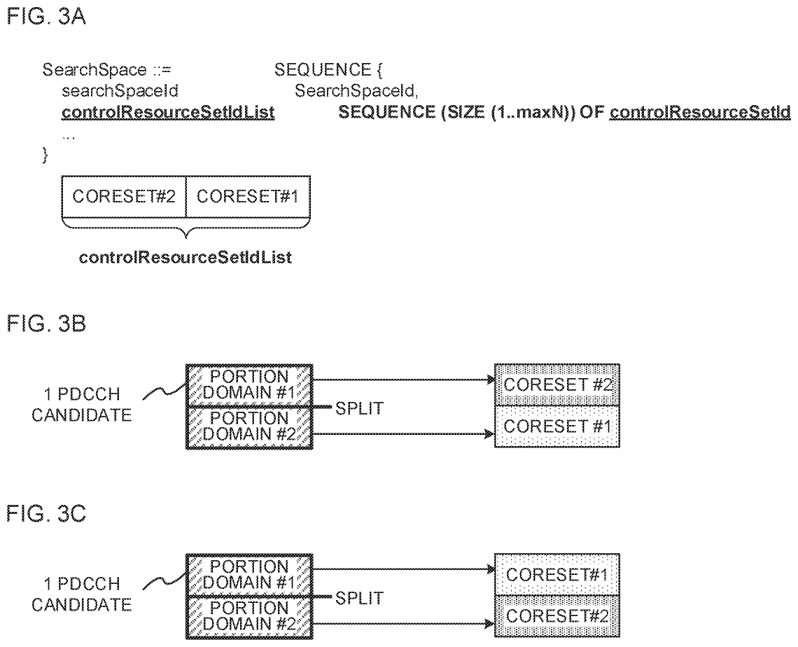

FIGS. 3A to 3C are diagrams illustrating one examples of a relation between portion domains and CORESETs according to the first aspect. The UE may receive configuration information (SS set configuration information) per SS set configured to the UE. FIG. 3A illustrates one example of the SS set configuration information.

As illustrated in FIG. 3A, the SS set configuration information may be, for example, a higher layer parameter “SearchSpace”. The SS set configuration information may include a list that indicates a plurality of CORESETs associated with an SS set #s. That the SS set configuration information includes the list may make the SS set configuration information different from a legacy higher layer parameter “SearchSpace” including information (e.g., higher layer parameter “controlResourceSetId”) that indicates a single CORESET associated with the SS set #s.

For example, as illustrated in FIG. 3A, the list may be a list (e.g., higher layer parameter “controlResourceSetIdlist”) of IDentifiers (IDs) (controlResourceSetId) of the CORESETs associated with the SS set #s.

As illustrated in FIG. 3A, the list may indicate the CORESET IDs associated with the SS set #s irrespectively of an ascending order or a descending order of the CORESET IDs. For example, the list illustrated in FIG. 3A first indicates the CORESET 42, and then indicates the CORESET #1.

The number of CORESETs (i.e., the number of CORESETs associated with the SS set #s) indicated by the list may be defined as a given value (e.g., 2) in advance by a specification, or may be configured to the UE by a higher layer parameter.

When the above list is included in the SS set configuration information, the UE may assume that each PDCCH candidate in the SS set #s configured by the SS set configuration information may be split into portion domains.

A plurality of portion domains that make up each PDCCH candidate in the SS set #s may be associated with a plurality of these CORESETs according to an order (e.g., the ascending order or the descending order) in the list. For example, as illustrated in FIG. 3B, the portion domains #1 and #2 that make up the PDCCH candidate in the SS set #s may be mapped on the CORESETs #2 and #1, respectively, according to the order (e.g., ascending order) in the list illustrated in FIG. 3A.

Alternatively, a plurality of portion domains that make up each PDCCH candidate in the SS set #s may be associated with a plurality of these CORESETs according to an order (e.g., the ascending order or the descending order) of the CORESET IDs in the list. For example, as illustrated in FIG. 3C, the portion domains #1 and #2 that make up the PDCCH candidate in the SS set #s may be mapped on the CORESETs #1 and #2, respectively, according to the order (e.g., ascending order) of the CORESET IDs in the list illustrated in FIG. 3A.

Furthermore, positions of a plurality of CORESETs (at least ones of time domain resources and frequency domain resources to which a plurality of these CORESETs are configured) associated with the SS set #s may be determined according to the order (e.g., the ascending order or the descending order) of the list, or may be determined according to the order (e.g., the ascending order or the descending order) of the CORESET IDs in the list.

According to, for example, the order (e.g., ascending order) in the list illustrated in FIG. 3A, the CORESET #2 may be configured to a first symbol, and the CORESET #1 may be configured to a next symbol in a slot. Alternatively, according to the order (e.g., ascending order) of the CORESET IDs in the list illustrated in FIG. 3A, the CORESET #1 may be configured to the first symbol, and the CORESET #2 may be configured to the next symbol in the slot.

According to the first aspect, one DCI is mapped on one PDCCH candidate in one SS set, and a plurality of portion domains obtained by splitting the one PDCCH candidate are associated with a plurality of CORESETs. As a result, the DCI is transmitted in a different TCI state (beam) associated with a plurality of these CORESETs, so that it is possible to improve received quality of the DCI.

### SECOND ASPECT

The second aspect differs from the first aspect in that DCI is mapped on a plurality of SS sets instead of one SS set. More specifically, in the second aspect, the DCI may be mapped in a plurality of SS sets respectively associated with a plurality of CORESETs. Differences from the first aspect will be mainly described below.

More specifically, a UE may monitor a plurality of SS sets respectively associated with a plurality of these CORESETs, and receive (detect) DCI that is mapped on a plurality of PDCCH candidates respectively included in a plurality of these SS sets.

Precoders may be different between a plurality of PDCCH candidates in each of a plurality of these SS sets. That is, different precoding weights (beams) may be applied between a plurality of these PDCCH candidates.

Furthermore, a plurality of PDCCH candidates in different SS sets are associated with different CORESETs, and therefore different TCI states may be applied to a plurality of these PDCCH candidates.

The UE may control reception processing (e.g., at least one of reception, demapping, demodulation and decoding) of the PDCCH candidate in the SS set associated with each of a plurality of these CORESETs based on a TCI state configured to each of a plurality of these CORESETs.

Furthermore, when a plurality of TCI states are configured to each CORESET, the UE may control the reception processing of the PDCCH candidate in the SS set associated with each CORESET based on the TCI state indicated by the MAC CE.

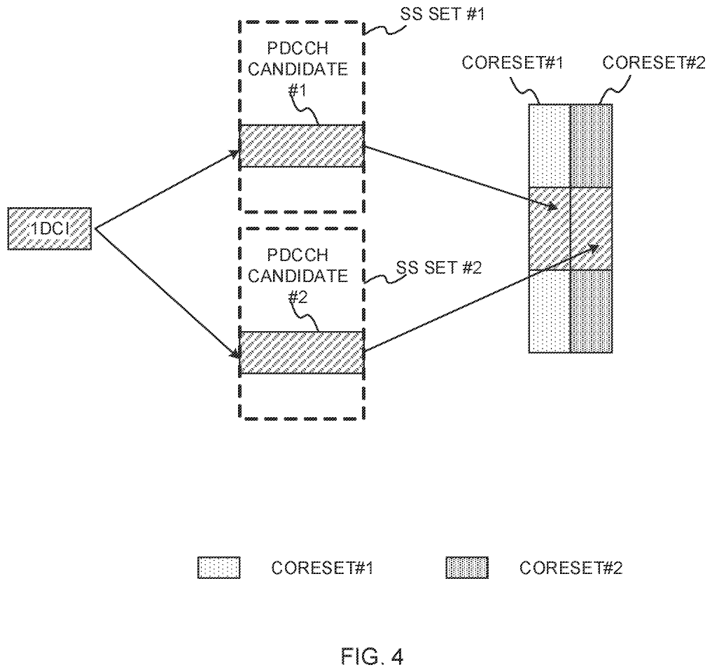

FIG. 4 is a diagram illustrating one example of a PDCCH structure according to the second aspect. A relation between one DCI and a plurality of SS sets and a relation between a plurality of SS sets and a plurality of CORESETs will be mainly described with reference to FIG. 4 on the premise of FIG. 1.

In addition, FIG. 4 illustrates one example where one DCI is mapped in two SS sets. However, the number of SS sets on which the one DCI is mapped may be 2 or more. Similarly, the number of CORESETs only needs to correspond to the number of SS sets on which the one DCI is mapped, and may be 2 or more.

As illustrated in FIG. 4, the one DCI may be mapped on a plurality of PDCCH candidates respectively included in a plurality of SS sets. For example, in FIG. 4, the one DCI is mapped on PDCCH candidates #1 and #2 included in SS sets #1 and #2, respectively.

Each SS set may be associated with a CORESET. The UE may receive configuration information (e.g., higher layer parameter “SearchSpace”) per SS set configured to the UE. The configuration information may include information (e.g., higher layer parameter “controlResourceSetId”) that indicates a single CORESET associated with an SS set #s.

For example, in FIG. 4, configuration information of the SS set #1 may include information that indicates the CORESET #1, and configuration information of the SS set #2 may include information that indicates the CORESET #2. The UT may associate the PDCCH candidates #1 and #2 included in the SS sets #1 and #2 with the CORESETs #1 and #2, respectively, based on the configuration information of the SS sets #1 and #2.

In FIG. 4, the precoders may be different between the PDCCH candidates #1 and #2 belonging to the different SS sets #1 and #2. For example, in FIG. 4, the UE may control reception processing of the PDCCH candidates #1 and #2 associated with the CORESETs #1 and #2, respectively, based on the TCI states respectively configured to the CORESETs #1 and #2.

### Association Between DCI, SS Sets and CORESETs

Hereinafter, an association between DCI and a plurality of SS sets and an association between each of a plurality of these SS sets and a CORESET will be described in detail.

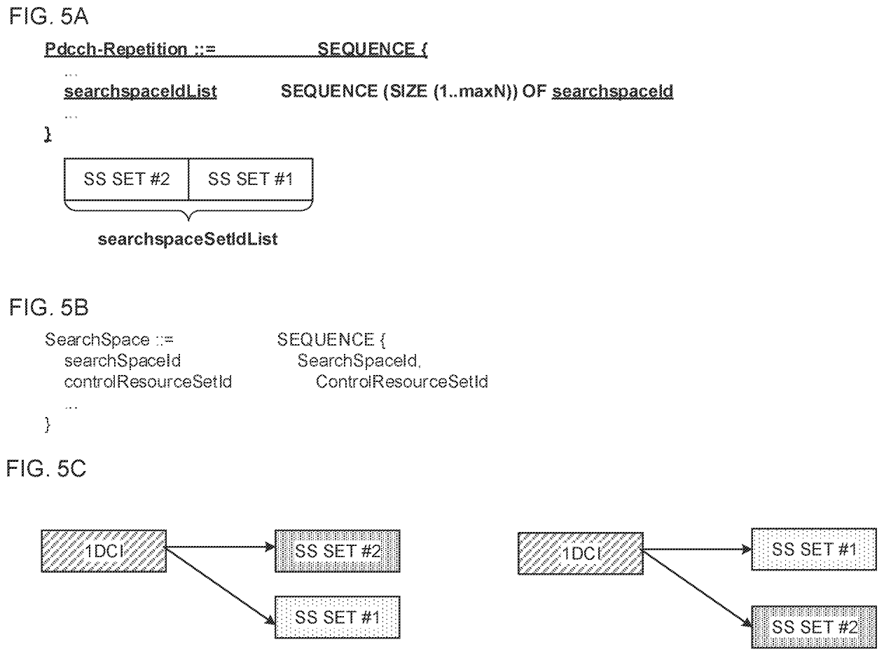

FIGS. 5A to 5C are diagrams illustrating one examples of a relation between DCI, SS sets and CORESETs according to the second aspect. The UE may receive information (association information) that indicates at least an association between the DCI and an SS set for monitoring the DCI. The association information may be a list that indicates a plurality of SS sets used to monitor the DCI.

For example, as illustrated in FIG. 5A, the list may be a list (e.g., higher layer parameter “searchspaceIdList”) of IDs of SS sets (searchspaceId) used to monitor the DCI. In addition, a name of the higher layer parameter corresponding to the list is not limited to “searchspaceIdList”.

Furthermore, in FIG. 5A, “searchspaceIdList” is included in a new higher layer parameter “pdccch-Repetition”. However, the list itself may be a new higher layer parameter “pdccch-Repetition”. In addition, pdccch-Repetition may be configuration information related to repetition of a PDCCH. pdccch-Repetition may be included in configuration information (e.g., “PDCCH-Config”) of the PDCCH per downlink BWP.

As illustrated in FIG. 5A, the list may indicate the SS set IDs associated with the DCI irrespectively of an ascending order or a descending order of the SS set IDs. For example, the list illustrated in FIG. 5A first indicates the SS set #2, and then indicates the SS set #1.

The number of SS sets (i.e., the number of SS sets associated with the one DCI) indicated by the list may be defined as a given value (e.g., 2) in advance by a specification, or may be configured to the UE by a higher layer parameter.

The UE may receive configuration information (e.g., higher layer parameter “SearchSpace”) of each SS set indicated by the above list. As illustrated in FIG. 5B, the configuration information may include information (e.g., higher layer parameter “controlResourceSetId”) that indicates a single CORESET associated with each SS set.

Thus, the UE may receive a list that indicates a plurality of SS sets used to monitor DCI, and information that indicates a CORESET associated with each SS indicated by the list. The UE may determine a plurality of SS sets associated with DCI based on the list, and determine a CORESET associated with each of a plurality of these SS sets based on the information.

Furthermore, the DCI may be mapped on a PDCCH candidate included in each of a plurality of these SS sets in an order (e.g., an ascending order or a descending order) in the list. Alternatively, the DCI may be mapped on a PDCCH candidate included in each of a plurality of these SS sets in an order (e.g., an ascending order or a descending order) of the SS set IDs in the list.

For example, as illustrated in FIG. 5C, the one DCI may be mapped on the SS sets #2 and #1 according to the order (e.g., ascending order) in the list illustrated in FIG. 5A, or may be mapped on the SS sets #1 and #2 according; to the order (e.g., ascending order) of the SS set IDs in the list.

According to the second aspect, one DCI is mapped on a plurality of PDCCH candidates respectively included in a plurality of SS sets, and a plurality of these SS sets are associated with different CORESETs. That is, according to the second aspect, one DCI (PDCCH) is repeated across a plurality of CORESETs. As a result, the DCI is transmitted in a different TCI state (beam) associated with a plurality of these CORESETs, so that it is possible to improve received quality of the DCI.

### Radio Communication System

The configuration of the radio communication system according to one embodiment of the present disclosure will be described below. This radio communication system uses one or a combination of the radio communication method according to each of the above embodiment of the present disclosure to perform communication.

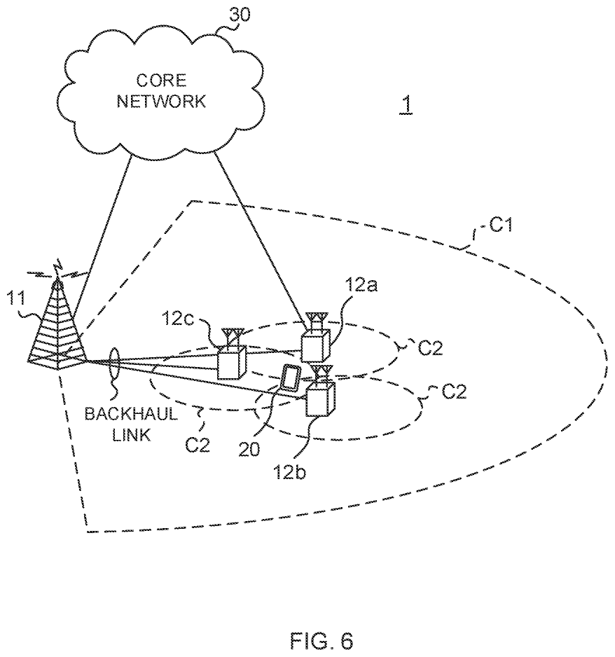

FIG. 6 is a diagram illustrating one example of a schematic configuration of the radio communication system according to the one embodiment. A radio communication system 1 may be a system that realizes communication by using Long Term Evolution (LTE) or the 5th generation mobile communication system New Radio (5G NR) specified by the Third Generation Partnership Project (3GPP).

Furthermore, the radio communication system 1 may support dual connectivity between a plurality of Radio Access Technologies (RATS) (Multi-RAT Dual Connectivity (MR-DC)). MR-DC may include dual connectivity (E-UTRA-NR Dual Connectivity (EN-DC)) of LTE (Evolved Universal Terrestrial Radio Access (E-UTRA)) and NR, and dual connectivity (NR-E-UTRA Dual Connectivity (NE-DC)) of NR and LTE.

According to EN-DC, a base station (eNB) of LTE (E-UTRA) is a Master Node (MN), and a base station (gNB) of NR is a Secondary Node (SN). According to NE-DC, a base station (gNB) of NR is an MN, and a base station (eNB) of LTE (E-UTRA) is an SN.

The radio communication system 1 may support dual connectivity between a plurality of base stations in an identical RAT (e.g., dual connectivity (NR-NR Dual Connectivity (NN-DC)) where both of the MN and the SN are base stations (gNBs) according to NR).

The radio communication system 1 includes a base station 11 that forms a macro cell C1 of a relatively wide coverage, and base stations 12 (12a to 12c) that are located in the macro cell C1 and form small cells C2 narrower than the macro cell C1. The user terminal 20 may be located in at least one cell. An arrangement and the numbers of respective cells and the user terminals 20 are not limited to the aspect illustrated in FIG. 6. The base stations 11 and 12 will be collectively referred to as a base station 10 below when not distinguished.

The user terminal 20 may connect with at least one of a plurality of base stations 10. The user terminal 20 may use at least one of Carrier Aggregation (CM and Dual Connectivity (DC) that use a plurality of Component Carriers (CCs).

Each CC may be included in at least one of a first frequency range (Frequency Range 1 (FR1) and a second frequency range (Frequency Range 2 (FR2)). The macro cell C1 may be included in the FR1, and the small cell C2 may be included in the FR2, For example, the FR1 may be a frequency range equal to or less than 6 GHz (sub-6 GHz), and the FR2 may be a frequency range higher than 24 GHz (above-24 GHz). In addition, the frequency ranges and definitions of the FR1 and the FR2 are not limited to these, and, for example, the FR1 may correspond to a frequency range higher than the FR2.

Furthermore, the user terminal 20 may perform communication by using at least one of Time Division Duplex (TDD) and Frequency Division Duplex (FDD) in each CC.

A plurality of base stations 10 may be connected by way of wired connection (e.g., optical fibers compliant with a Common Public Radio Interface (CPRI) or an X2 interface) or radio connection (e.g., NR communication). When, for example, NR communication is used as backhaul between the base stations 11 and 12, the base station 11 corresponding to a higher station may be referred to as an Integrated Access Backhaul (IAB) donor, and the base station 12 corresponding to a relay station (relay) may be referred to as an IAB node.

The base station 10 may be connected with a core network 30 via the another base station 10 or directly. The core network 30 may include at least one of, for example, an Evolved Packet Core (EPC), a 5G Core Network (5GCN) and a Next Generation Core (NGC).

The user terminal 20 is a terminal that supports at least one of communication schemes such as LTE, LTE-A and 5G.

The radio communication system 1 may use an Orthogonal Frequency Division Multiplexing (OFDM)-based radio access scheme. For example, on at least one of Downlink (DL) and Uplink (UL), Cyclic Prefix OFDM (CP-OFDM), Discrete Fourier Transform Spread OFDM (DFT-s-OFDM), Orthogonal Frequency Division Multiple Access (OFDMA) and Single Carrier Frequency Division Multiple Access (SC-FDMA) may be used.

The radio access scheme may be referred to as a waveform. In addition, the radio communication system 1 may use another radio access scheme (e.g., another single carrier transmission scheme or another multicarrier transmission scheme) as the radio access scheme on UL and DL.

The radio communication system 1 may use a downlink shared channel (Physical Downlink Shared Channel (PDSCH)) shared by each user terminal 20, a broadcast channel (Physical Broadcast Channel (PBCH)) and a downlink control channel (Physical Downlink Control Channel (PDCCH)) as downlink channels.

Furthermore, the radio communication system 1 uses an uplink shared channel (Physical Uplink Shared Channel (PUSCH)) shared by each user terminal 20, an uplink control channel (Physical Uplink Control Channel (PUCCH)) and a random access channel (Physical Random Access Channel (PRACH)) as uplink channels.

User data, higher layer control information and a System Information Block (SIB) are conveyed on the PDSCH. The user data and the higher layer control information may be conveyed on the PUSCH. Furthermore, a Master Information Block (MIB) may be conveyed on the PBCH.

Lower layer control information may be conveyed on the PDCCH. The lower layer control information may include, for example, Downlink Control Information (DCI) including scheduling information of at least one of the PDSCH and the PUSCH.

In addition, DCI for scheduling the PDSCH may be referred to as, for example, a DL assignment or DL DCI, and DCI for scheduling the PUSCH may be referred to as, for example, a UL grant or UL DCI. In this regard, the PDSCH may be read as DL data, and the PUSCH may be read as UL data.

A COntrol REsource SET (CORESET) and a search space may be used to detect the PDCCH. The CORESET corresponds to a resource for searching DCI. The search space corresponds to a search domain and a search method of PDCCH candidates. One CORESET may be associated with one or a plurality of search spaces. The UE may monitor a CORESET associated with a certain search space based on a search space configuration.

One search space may be associated with a PDCCH candidate corresponding to one or a plurality of aggregation levels. One or a plurality of search spaces may be referred to as a search space set. In addition, a “search space”, a “search space set”, a “search space configuration”, a “search space set configuration”, a “CORESET” and a “CORESET configuration” in the present disclosure may be interchangeably read.

Uplink Control Information (UCI) including at least one of Channel State Information (CSI), transmission acknowledgement information (that may be referred to as, for example, Hybrid Automatic Repeat reQuest ACKnowledgement (HARQ-ACK) or ACK/NACK) or a Scheduling Request (SR) may be conveyed on the PUCCH. A random access preamble for establishing connection with a cell may be conveyed on the PRACH.

In addition, downlink and uplink in the present disclosure may be expressed without adding “link” thereto. Furthermore, various channels may be expressed without adding “physical” to heads of the various channels.

The radio communication system 1 may convey a Synchronization Signal (SS) and a Downlink Reference Signal (DL-RS). The radio communication system 1 may convey a Cell-specific Reference Signal (CRS), a Channel State Information Reference Signal (CSI-RS), a DeModulation Reference Signal (DMRS), a Positioning Reference Signal (PRS) and a Phase Tracking Reference Signal (PTRS) as DL-RSs.

The synchronization signal may be at least one of, for example, a Primary Synchronization Signal (PSS) and a Secondary Synchronization Signal (SSS). A signal block including the SS (the PSS or the SSS) and the PBCH (and the DMRS for the PBCH) may be referred to as, for example, an SS/PBCH block or an SS Block (SSB). In addition, the SS and the SSB may be also referred to as reference signals.

Furthermore, the radio communication system 1 may convey a Sounding Reference Signal (SRS) and a DeModulation Reference Signal (DMRS) as UpLink Reference Signals (UL-RSs). In this regard, the DMRS may be referred to as a user terminal-specific reference signal (UE-specific reference signal).

### Base Station

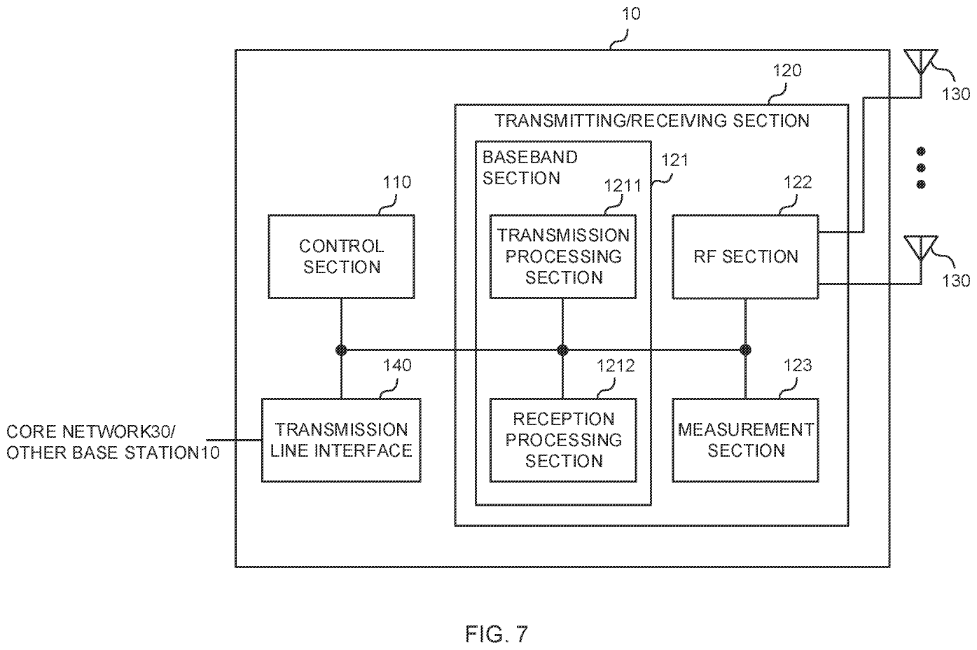

FIG. 7 is a diagram illustrating one example of a configuration of the base station according to the one embodiment. The base station 10 includes a control section 110, a transmitting/receiving section 120, transmission/reception antennas 130 and a transmission line interface 140. In addition, the base station 10 may include one or more of each of the control sections 110, the transmitting/receiving sections 120, the transmission/reception antennas 130 and the transmission line interfaces 140.

In addition, this example mainly illustrates function blocks of characteristic portions according to the present embodiment, and may assume that the base station 10 includes other function blocks, too, that are necessary for radio communication. Part of processing of each section described below may be omitted.

The control section 110 controls the entire base station 10. The control section 110 can be composed of a controller or a control circuit described based on the common knowledge in the technical field according to the present disclosure.

The control section 110 may control signal generation and scheduling (e.g., resource allocation or mapping). The control section 110 may control transmission/reception and measurement that use the transmitting/receiving section 120, the transmission/reception antennas 130 and the transmission line interface 140. The control section 110 may generate data, control information or a sequence to be transmitted as a signal, and forward the signal to the transmitting/receiving section 120. The control section 110 may perform call processing (such as configuration and release) of a communication channel, state management of the base station 10 and radio resource management.

The transmitting/receiving section 120 may include a baseband section 121, a Radio Frequency (RF) section 122 and a measurement section 123. The baseband section 121 may include a transmission processing section 1211 and a reception processing section 1212. The transmitting/receiving section 120 can be composed of a transmitter/receiver, an RF circuit, a baseband circuit, a filter, a phase shifter, a measurement circuit and a transmission/reception circuit described based on the common knowledge in the technical field according to the present disclosure.

The transmitting/receiving section 120 may be composed as an integrated transmitting/receiving section, or may be composed of a transmitting section and a receiving section. The transmitting section may be composed of the transmission processing section 1211 and the RF section 122. The receiving section may be composed of the reception processing section 1212, the RF section 122 and the measurement section 123.

The transmission/reception antenna 130 can be composed of an antenna such as an array antenna described based on the common knowledge in the technical field according to the present disclosure.

The transmitting/receiving section 120 may transmit the above-described downlink channel, synchronization signal and downlink reference signal. The transmitting/receiving section 120 may receive the above-described uplink channel and uplink reference signal.

The transmitting/receiving section 120 may form at least one of a transmission beam and a reception beam by using digital beam forming (e.g., precoding) or analog beam forming (e.g., phase rotation).

The transmitting/receiving section 120 (transmission processing section 1211) may perform Packet Data Convergence Protocol (PDCP) layer processing, Radio Link Control (RLC) layer processing (e.g., RLC retransmission control), and Medium Access Control (MAC) layer processing (e.g., HARQ retransmission control) on, for example, the data and the control information obtained from the control section 110, and generate a bit sequence to transmit.

The transmitting/receiving section 120 (transmission processing section 1211) may perform transmission processing such as channel coding (that may include error correction coding), modulation, mapping, filter processing, Discrete Fourier Transform (DFT) processing (when needed), Inverse Fast Fourier Transform (IFFT) processing, precoding and digital-analog conversion on the bit sequence to transmit, and output a baseband signal.

The transmitting/receiving section 120 (RF section 122) may modulate the baseband signal into a radio frequency range, perform filter processing and amplification on the signal, and transmit the signal of the radio frequency range via the transmission/reception antennas 130.

On the other hand, the transmitting/receiving section 120 (RF section 122) may perform amplification and filter processing on the signal of the radio frequency range received by the transmission/reception antennas 130, and demodulate the signal into a baseband signal.

The transmitting/receiving section 120 (reception processing section 1212) may apply reception processing such as analog-digital conversion, Fast Fourier Transform (FFT) processing, Inverse Discrete Fourier Transform (IDFT) processing (when needed), filter processing, demapping, demodulation, decoding (that may include error correction decoding), MAC layer processing, RLC layer processing and PDCP layer processing to the obtained baseband signal, and obtain user data.

The transmitting/receiving section 120 (measurement section 123) may perform measurement related to the received signal. For example, the measurement section 123 may perform Radio Resource Management (RRM) measurement or Channel State Information (CSI) measurement based on the received signal. The measurement section 123 may measure received power (e.g., Reference Signal Received Power (RSRP)), received quality (e.g., Reference Signal Received Quality (RSRQ), a Signal to Interference plus Noise Ratio (SINR) or a Signal to Noise Ratio (SNR)), a signal strength (e.g., a Received Signal Strength indicator (RSSI)) or channel information (e.g., CSI). The measurement section 123 may output a measurement result to the control section 110.

The transmission line interface 140 may transmit and receive (backhaul signaling) signals to and from apparatuses and the other base stations 10 included in the core network 30, and obtain and convey user data (user plane data) and control plane data for the user terminal 20.

In addition, the transmitting section and the receiving section of the base station 10 according to the present disclosure may be composed of at least one of the transmitting/receiving section 120, the transmission/reception antenna 130 and the transmission line interface 140.

In addition, the transmitting/receiving section 120 may transmit downlink control information. More specifically, the transmitting/receiving section 120 may transmit the downlink control information that is mapped on a downlink control channel candidate included in one search space set (first aspect). Alternatively, the transmitting/receiving section 120 may transmit the downlink control information that is mapped on a plurality of downlink control channel candidates respectively included in a plurality of these search space sets (second aspect).

Furthermore, the transmitting/receiving section 120 may transmit a list that indicates a plurality of these control resource sets associated with one search space set (first aspect). Alternatively, the transmitting/receiving section 120 may transmit a list that indicates a plurality of these search space sets on which the downlink control information is mapped (second aspect).

Furthermore, the transmitting/receiving section 120 may transmit configuration information of each search space set configured to the user terminal 20. Furthermore, the transmitting/receiving section 120 may transmit configuration information of each control resource set configured to the user terminal 20.

Furthermore, the control section 110 may control mapping of the downlink control information in each search space set configured to the user terminal 20. More specifically, the control section 110 may control mapping of the downlink control information on a downlink control channel candidate included in one search space set associated with a plurality of control resource sets (first aspect). Alternatively, the control section 110 may control mapping of the downlink control information on a plurality of downlink control channel candidates respectively included in a plurality of search space sets associated with a plurality of control resource sets (second aspect).

Furthermore, the control section 110 may associate a plurality of portion domains obtained by splitting the downlink control channel candidate included in the one search space set, respectively with a plurality of these control resource sets (first aspect).

Furthermore, the control section 110 may associate a plurality of these search space sets on which the downlink control information is mapped, with a plurality of these control resource sets (second aspect).

### User Terminal

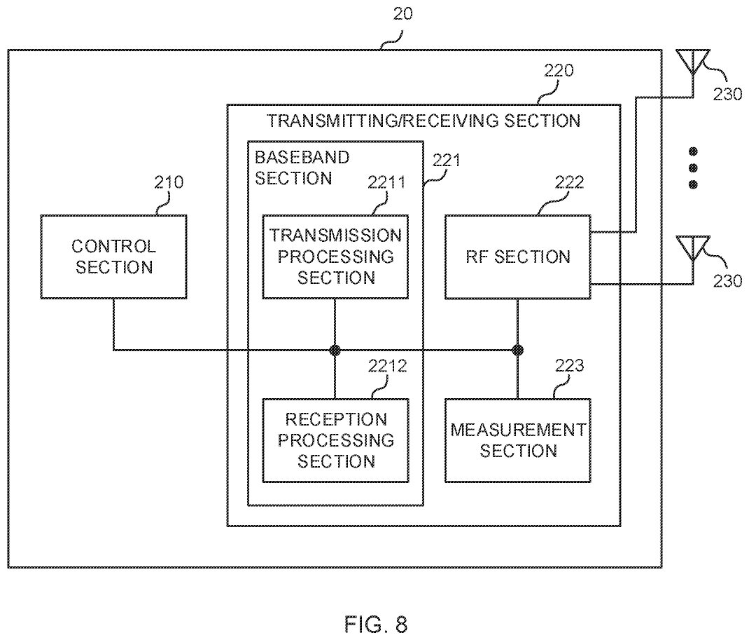

FIG. 8 is a diagram illustrating one example of a configuration of the user terminal according to the one embodiment. The user terminal 20 includes a control section 210, a transmitting/receiving section 220 and transmission/reception antennas 230. In this regard, the user terminal 20 may include one or more of each of the control sections 210, the transmitting/receiving sections 220 and the transmission/reception antennas 230.

In addition, this example mainly illustrates function blocks of characteristic portions according to the present embodiment, and may assume that the user terminal 20 includes other function blocks, too, that are necessary for radio communication. Part of processing of each section described below may be omitted.

The control section 210 controls the entire user terminal 20. The control section 210 can be composed of a controller or a control circuit described based on the common knowledge in the technical field according to the present disclosure.

The control section 210 may control signal generation and mapping. The control section 210 may control transmission/reception and measurement that use the transmitting/receiving section 220 and the transmission/reception antennas 230. The control section 210 may generate data, control information or a sequence to be transmitted as a signal, and forward the signal to the transmitting/receiving section 220.

The transmitting/receiving section 220 may include a baseband section 221, an RF section 222 and a measurement section 223. The baseband section 221 may include a transmission processing section 2211 and a reception processing section 2212. The transmitting/receiving section 220 can be composed of a transmitter/receiver, an RF circuit, a baseband circuit, a filter, a phase shifter, a measurement circuit and a transmission/reception circuit described based on the common knowledge in the technical field according to the present disclosure.

The transmitting/receiving section 220 may be composed as an integrated transmitting/receiving section, or may be composed of a transmitting section and a receiving section. The transmitting section may be composed of the transmission processing section 2211 and the RF section 222. The receiving section may be composed of the reception processing section 2212, the RF section 222 and the measurement section 223.

The transmission/reception antenna 230 can be composed of an antenna such as an array antenna described based on the common knowledge in the technical field according to the present disclosure.

The transmitting/receiving section 220 may receive the above-described downlink channel, synchronization signal and downlink reference signal. The transmitting/receiving section 220 may transmit the above-described uplink channel and uplink reference signal.

The transmitting/receiving section 220 may form at least one of a transmission beam and a reception beam by using digital beam forming (e.g., precoding) or analog beam forming (e.g., phase rotation).

The transmitting/receiving section 220 (transmission processing section 2211) may perform PDCP layer processing, RLC layer processing (e.g., RLC retransmission control) and MAC layer processing (e.g., HARQ retransmission control) on, for example, the data and the control information obtained from the control section 210, and generate a bit sequence to transmit.

The transmitting/receiving section 220 (transmission processing section 2211) may perform transmission processing such as channel coding (that may include error correction coding), modulation, mapping, filter processing, DFT processing (when needed), IFFT processing, precoding and digital-analog conversion on the bit sequence to transmit, and output a baseband signal.

In this regard, whether or not to apply the DFT processing may be based on a configuration of transform precoding. When transform precoding is enabled for a certain channel (e.g., PUSCH), the transmitting/receiving section 220 (transmission processing section 2211) may perform the DFT processing as the above transmission processing to transmit the certain channel by using a DFT-s-OFDM waveform. When precoding is not enabled, the transmitting/receiving section 220 (transmission processing section 2211) may not perform the DFT processing as the above transmission processing.

The transmitting/receiving section 220 (RF section 222) may modulate the baseband signal into a radio frequency range, perform filter processing and amplification on the signal, and transmit the signal of the radio frequency range via the transmission/reception antennas 230.

On the other hand, the transmitting/receiving section 220 (RF section 222) may perform amplification and filter processing on the signal of the radio frequency range received by the transmission/reception antennas 230, and demodulate the signal into a baseband signal.

The transmitting/receiving section 220 (reception processing section 2212) may apply reception processing such as analog-digital conversion, FFT processing, IDFT processing (when needed), filter processing, demapping, demodulation, decoding (that may include error correction decoding), MAC layer processing, RLC layer processing and PDCP layer processing to the obtained baseband signal, and obtain user data.

The transmitting/receiving section 220 (measurement section 223) may perform measurement related to the received signal. For example, the measurement section 223 may perform RRM measurement or CSI measurement based on the received signal. The measurement section 223 may measure received power (e.g., RSRP), received quality (e.g., RSRQ, an SINR or an SNR), a signal strength (e.g., RSSI) or channel information (e.g., CSI). The measurement section 223 may output a measurement result to the control section 210.

In addition, the transmitting section and the receiving section of the user terminal 20 according to the present disclosure may be composed of at least one of the transmitting/receiving section 220 and the transmission/reception antenna 230.

In addition, the transmitting/receiving section 220 may receive the downlink control information. More specifically, the transmitting/receiving section 220 may receive the downlink control information that is mapped on the downlink control channel candidate included in the one search space set (first aspect). Alternatively, the transmitting/receiving section 220 may receive the downlink control information that is mapped on a plurality of downlink control channel candidates respectively included in a plurality of these search space sets (second aspect).

Furthermore, the transmitting/receiving section 220 may receive the list that indicates a plurality of these control resource sets associated with the one search space set (first aspect). Alternatively, the transmitting/receiving section 220 may receive the list that indicates a plurality of these search space sets on which the downlink control information is mapped (second aspect).

Furthermore, the transmitting/receiving section 220 may receive the configuration information of each search space set configured to the user terminal 20. Furthermore, the transmitting/receiving section 220 may receive the configuration information of each control resource set configured to the user terminal 20.

Furthermore, the control section 210 may control monitoring of each search space set configured to the user terminal 20. More specifically, the control section 210 may control monitoring of the one search space set associated with a plurality of control resource sets (first aspect). Alternatively, the control section 210 may control monitoring of a plurality of search space sets associated with a plurality of control resource sets (second aspect).

Furthermore, the control section 210 may associate a plurality of portion domains obtained by splitting the downlink control channel candidate included in the one search space set, respectively with a plurality of these control resource sets (first aspect).

Furthermore, the control section 210 may associate a plurality of these search space sets on which the downlink control information is mapped, with a plurality of these control resource sets (second aspect).

### Hardware Configuration

In addition, the block diagrams used to describe the above embodiment illustrate blocks in function units. These function blocks (components) are realized by an arbitrary combination of at least ones of hardware components and software components. Furthermore, a method for realizing each function block is not limited in particular. That is, each function block may be realized by using one physically or logically coupled apparatus or may be realized by connecting two or more physically or logically separate apparatuses directly or indirectly (by using, for example, wired connection or radio connection) and using a plurality of these apparatuses. Each function block may be realized by combining software with the above one apparatus or a plurality of above apparatuses.

In this regard, the functions include deciding, determining, judging, calculating, computing, processing, deriving, investigating, looking up, ascertaining, receiving, transmitting, outputting, accessing, resolving, selecting, choosing, establishing, comparing, assuming, expecting, considering, broadcasting, notifying, communicating, forwarding, configuring, reconfiguring, allocating, mapping, and assigning, yet are not limited to these. For example, a function block (component) that causes transmission to function may be referred to as, for example, a transmitting unit or a transmitter. As described above, the method for realizing each function block is not limited in particular.

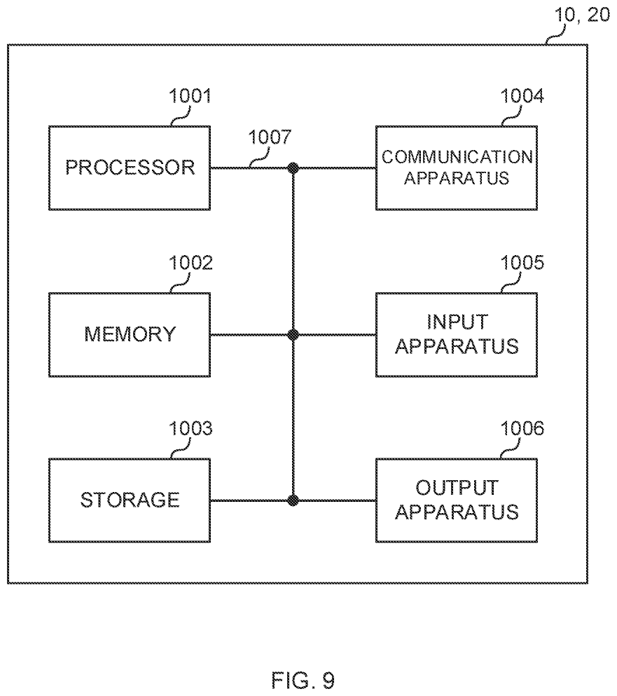

For example, the base station and the user terminal according to the one embodiment of the present disclosure may function as computers that perform processing of the radio communication method according to the present disclosure. FIG. 9 is a diagram illustrating one example of the hardware configurations of the base station and the user terminal according to the one embodiment. The above-described base station 10 and user terminal 20 may be each physically configured as a computer apparatus that includes a processor 1001, a memory 1002, a storage 1003, a communication apparatus 1004, an input apparatus 1005, an output apparatus 1006 and a bus 1007.

In this regard, words such as an apparatus, a circuit, a device, a section and a unit in the present disclosure can be interchangeably read. The hardware configurations of the base station 10 and the user terminal 20 may be configured to include one or a plurality of apparatuses illustrated in FIG. 9 or may be configured without including part of the apparatuses.

For example, FIG. 9 illustrates the only one processor 1001. However, there may be a plurality of processors. Furthermore, processing may be executed by 1 processor or processing may be executed by 2 or more processors simultaneously or successively or by using another method. In addition, the processor 1001 may be implemented by 1 or more chips.

Each function of the base station 10 and the user terminal 20 is realized by, for example, causing hardware such as the processor 1001 and the memory 1002 to read given software (program), and thereby causing the processor 1001 to perform an operation, and control communication via the communication apparatus 1004 and control at least one of reading and writing of data in the memory 1002 and the storage 1003.

The processor 1001 causes, for example, an operating system to operate to control the entire computer. The processor 1001 may be composed of a Central Processing Unit (CPU) including an interface for a peripheral apparatus, a control apparatus, an operation apparatus and a register. For example, at least part of the above-described control section 110 (210) and transmitting/receiving section 120 (220) may be realized by the processor 1001.

Furthermore, the processor 1001 reads programs (program codes), software modules or data from at least one of the storage 1003 and the communication apparatus 1004 out to the memory 1002, and executes various types of processing according to these programs, software modules or data. As the programs, programs that cause the computer to execute at least part of the operations described in the above-described embodiment are used. For example, the control section 110 (210) may be realized by a control program that is stored in the memory 1002 and operates on the processor 1001, and other function blocks may be also realized likewise.

The memory 1002 is a computer-readable recording medium, and may be composed of at least one of, for example, a Read Only Memory (ROM), an Erasable Programmable ROM (EPROM), an Electrically EPROM (EEPROM), a Random Access Memory (RAM) and other appropriate storage media. The memory 1002 may be referred to as, for example, a register, a cache or a main memory (main storage apparatus). The memory 1002 can store programs (program codes) and software modules that can be executed to perform the radio communication method according to the one embodiment of the present disclosure.

The storage 1003 is a computer-readable recording medium, and may be composed of at least one of, for example, a flexible disk, a floppy (registered trademark) disk, a magnetooptical disk (e.g., a compact disk (Compact Disc ROM (CD-ROM)), a digital versatile disk and a Blu-ray (registered trademark) disk), a removable disk, a hard disk drive, a smart card, a flash memory device (e.g., a card, a stick or a key drive), a magnetic stripe, a database, a server and other appropriate storage media. The storage 1003 may be referred to as an auxiliary storage apparatus.

The communication apparatus 1004 is hardware (transmission/reception device) that performs communication between computers via at least one of a wired network and a radio network, and is also referred to as, for example, a network device, a network controller, a network card and a communication module. The communication apparatus 1004 may be configured to include a high frequency switch, a duplexer, a filter and a frequency synthesizer to realize at least one of, for example, Frequency Division Duplex (MD) and Time Division Duplex (TDD). For example, the above-described transmitting/receiving section 120 (220) and transmission/reception antennas 130 (230) may be realized by the communication apparatus 1004. The transmitting/receiving section 120 (220) may be physically or logically separately implemented as a transmitting section 120a (220a) and a receiving section 120b (220b).

The input apparatus 1005 is an input device (e.g., a keyboard, a mouse, a microphone, a switch, a button or a sensor) that accepts an input from an outside. The output apparatus 1006 is an output device (e.g., a display, a speaker or a Light Emitting Diode (LED) lamp) that sends an output to the outside. In addition, the input apparatus 1005 and the output apparatus 1006 may be an integrated component (e.g., touch panel).

Furthermore, each apparatus such as the processor 1001 or the memory 1002 is connected by the bus 1007 that communicates information. The bus 1007 may be composed by using a single bus or may be composed by using different buses between apparatuses.

Furthermore, the base station 10 and the user terminal 20 may be configured to include hardware such as a microprocessor, a Digital Signal Processor (DSP), an Application Specific Integrated Circuit (ASIC), a Programmable Logic Device (PLD) and a Field Programmable Gate Array (FPGA). The hardware may be used to realize part or entirety of each function block. For example, the processor 1001 may be implemented by using at least one of these hardware components.

### MODIFIED EXAMPLE

In addition, each term that has been described in the present disclosure and each term that is necessary to understand the present disclosure may be replaced with terms having identical or similar meanings. For example, a channel, a symbol and a signal (a signal or a signaling) may be interchangeably read. Furthermore, a signal may be a message. A reference signal can be also abbreviated as an RS, or may be referred to as a pilot or a pilot signal depending on standards to be applied. Furthermore, a Component Carrier (CC) may be referred to as, for example, a cell, a frequency carrier and a carrier frequency.

A radio frame may include one or a plurality of durations (frames) in a time domain. Each of one or a plurality of durations (frames) that makes up a radio frame may be referred to as a subframe. Furthermore, the subframe may include one or a plurality of slots in the time domain. The subframe may be a fixed time duration (e.g., 1 ms) that does not depend on a numerology.

In this regard, the numerology may be a communication parameter to be applied to at least one of transmission and reception of a certain signal or channel. The numerology may indicate at least one of, for example, a SubCarrier Spacing (SCS), a bandwidth, a symbol length, a cyclic prefix length, a Transmission Time Interval (TTI), the number of symbols per TTI, a radio frame configuration, specific filtering processing performed by a transceiver in a frequency domain, and specific windowing processing performed by the transceiver in a time domain.

The slot may include one or a plurality of symbols (Orthogonal Frequency Division Multiplexing (OFDM) symbols or Single Carrier Frequency Division Multiple Access (SC-FDMA) symbols) in the time domain. Furthermore, the slot may be a time unit based on the numerology.

The slot may include a plurality of mini slots. Each mini slot may include one or a plurality of symbols in the time domain. Furthermore, the mini slot may be referred to as a subslot. The mini slot may include a smaller number of symbols than that of the slot. The PDSCH (or the PUSCH) to be transmitted in larger time units than that of the mini slot may be referred to as a PDSCH (PUSCH) mapping type A. The PDSCH (or the PUSCH) to be transmitted by using the mini slot may be referred to as a PDSCH (PUSCH) mapping type B.

The radio frame, the subframe, the slot, the mini slot and the symbol each indicate a time unit for conveying signals. The other corresponding names may be used for the radio frame, the subframe, the slot, the mini slot and the symbol. In addition, time units such as a frame, a subframe, a slot, a mini slot and a symbol in the present disclosure may be interchangeably read.

For example, 1 subframe may be referred to as a TTI, a plurality of contiguous subframes may be referred to as TTIs, or 1 slot or 1 mini slot may be referred to as a TTI. That is, at least one of the subframe and the TTI may be a subframe (1 ms) according to legacy LTE, may be a duration (e.g., 1 to 13 symbols) shorter than 1 ms or may be a duration longer than 1 ms. In addition, a unit that indicates the TTI may be referred to as, for example, a slot or a mini slot instead of a subframe.

In this regard, the TTI refers to, for example, a minimum time unit of scheduling of radio communication. For example, in the LTE system, the base station performs scheduling for allocating radio resources (a frequency bandwidth or transmission power that can be used in each user terminal) in TTI units to each user terminal. In this regard, a definition of the TTI is not limited to this.

The TTI may be a transmission time unit of a channel-coded data packet (transport block), code block or codeword, or may be a processing unit of scheduling or link adaptation. In addition, when the TTI is given, a time period (e.g., the number of symbols) in which a transport block, a code block or a codeword is actually mapped may be shorter than the TTI.

In addition, when 1 slot or 1 mini slot is referred to as a TTI, 1 or more TTIs (i.e., 1 or more slots or 1 or more mini slots) may be a minimum time unit of scheduling. Furthermore, the number of slots (the number of mini slots) that make up a minimum time unit of the scheduling may be controlled.

The TTI having the time duration of 1 ms may be referred to as, for example, a general TTI (TTIs according to 3GPP Rel. 8 to 12), a normal TTI, a long ITT a general subframe, a normal subframe, a long subframe or a slot. A TTI shorter than the general TTI may be referred to as, for example, a reduced TTI, a short TTI, a partial or fractional TTI, a reduced subframe, a short subframe, a mini slot, a subslot or a slot.

In addition, the long TTI (e.g., the general TTI or the subframe) may be read as a TTI having a time duration exceeding 1 ms, and the short TTI (e.g., the reduced TTI) may be read as a TTI having a TTI length less than the TTI length of the long and equal to or more than 1 ms.

A Resource Block (RB) is a resource allocation unit of the time domain and the frequency domain, and may include one or a plurality of contiguous subcarriers in the frequency domain. The numbers of subcarriers included in RBs may be the same irrespectively of a numerology, and may be, for example, 12. The numbers of subcarriers included in the RBs may be determined based on the numerology.

Furthermore, the RB may include one or a plurality of symbols in the time domain or may have the length of 1 slot, 1 mini slot, 1 subframe or 1 TTI. 1 TTI or 1 subframe may each include one or a plurality of resource blocks.

In this regard, one or a plurality of RBs may be referred to as, for example, a Physical Resource Block (Physical RB (PRB)), a Sub-Carrier Group (SCG), a Resource Element Group (REG), a PRB pair or an RB pair.

Furthermore, the resource block may include one or a plurality of Resource Elements (REs). For example, 1 RE may be a radio resource domain of 1 subcarrier and 1 symbol.

A Bandwidth Part (BWP) (that may be referred to as, for example, a partial bandwidth) may mean a subset of contiguous common Resource Blocks (common RBs) for a certain numerology in a certain carrier. In this regard, the common RB may be specified by an RB index based on a common reference point of the certain carrier. A PRB may be defined based on a certain BWP, and may be numbered in the certain BWP.

The BWP may include a UL BWP (a BWP for UL) and a DL BWP (a BWP for DL). One or a plurality of BWPs in 1 carrier may be configured to the UE.

At least one of the configured BWPs may be active, and the UE may not assume to transmit and receive given signals/channels outside the active BWP. In addition, a “cell” and a “carrier” in the present disclosure may be read as a “BWP”.

In this regard, structures of the above-described radio frame, subframe, slot, mini slot and symbol are only exemplary structures. For example, configurations such as the number of subframes included in a radio frame, the number of slots per subframe or radio frame, the number of mini slots included in a slot, the numbers of symbols and RBs included in a slot or a mini slot, the number of subcarriers included in an RB, the number of symbols in a TTI, a symbol length and a Cyclic Prefix (CP) length can be variously changed.

Furthermore, the information and the parameters described in the present disclosure may be expressed by using absolute values, may be expressed by using relative values with respect to given values or may be expressed by using other corresponding information. For example, a radio resource may be instructed by a given index.

Names used for parameters in the present disclosure are in no respect restrictive names. Furthermore, numerical expressions that use these parameters may be different from those explicitly disclosed in the present disclosure. Various channels (the PUCCH and the PDCCH) and information elements can be identified based on various suitable names. Therefore, various names assigned to these various channels and information elements are in no respect restrictive names.

The information and the signals described in the present disclosure may be expressed by using one of various different techniques. For example, the data, the instructions, the commands, the information, the signals, the bits, the symbols and the chips mentioned in the above entire description may be expressed as voltages, currents, electromagnetic waves, magnetic fields or magnetic particles, optical fields or photons, or arbitrary combinations of these.

Furthermore, the information and the signals can be output at least one of from a higher layer to a lower layer and from the lower layer to the higher layer. The information and the signals may be input and output via a plurality of network nodes.

The input and output information and signals may be stored in a specific location (e.g., memory) or may be managed by using a management table. The information and signals to be input and output can be overridden, updated or additionally written. The output information and signals may be deleted. The input information and signals may be transmitted to other apparatuses.

Notification of information is not limited to the aspects/embodiment described in the present disclosure and may be performed by using other methods. For example, the information may be notified in the present disclosure by a physical layer signaling (e.g., Downlink Control Information (DCI) and Uplink Control Information (UCI)), a higher layer signaling (e.g., a Radio Resource Control (RRC) signaling, broadcast information (such as a Master Information Block (MIB) and a System Information Block (SIB)), and a Medium Access Control (MAC) signaling), other signals or combinations of these.

In addition, the physical layer signaling may be referred to as Layer 1/Layer 2 (L1/L2) control information (L1/L2 control signal) or L1 control information (L1 control signal). Furthermore, the RRC signaling may be referred to as an RRC message, and may be, for example, an RRCConnectionSetup message or an RRCConnectionReconfiguration message. Furthermore, the MAC signaling may be notified by using, for example, an MAC Control Element (MAC CE).

Furthermore, notification of given information (e.g., notification of “being X”) is not limited to explicit notification, and may be given implicitly (by, for example, not giving notification of the given information or by giving notification of another information).

Judgement may be made based on a value (0 or 1) expressed as 1 bit, may be made based on a boolean expressed as true or false or may be made by comparing numerical values (by, for example, making comparison with a given value).

Irrespectively of whether software is referred to as software, firmware, middleware, a microcode or a hardware description language or is referred to as other names, the software should be widely interpreted to mean a command, a command set, a code, a code segment, a program code, a program, a subprogram, a software module, an application, a software application, a software package, a routine, a subroutine, an object, an executable file, an execution thread, a procedure or a function.

Furthermore, software, commands and information may be transmitted and received via transmission media. When, for example, the software is transmitted from websites, servers or other remote sources by using at least ones of wired techniques (e.g., coaxial cables, optical fiber cables, twisted pairs and Digital Subscriber Lines (DSLs)) and radio techniques (e.g., infrared rays and microwaves), at least ones of these wired techniques and radio techniques are included in a definition of the transmission media.

The terms “system” and “network” used in the present disclosure can be interchangeably used. The “network” may mean an apparatus (e.g., base station) included in the network.

In the present disclosure, terms such as “precoding”, a “precoder”, a “weight (precoding weight)”, “Quasi-Co-Location (QCL)”, a “Transmission Configuration indication state (TCI state)”, a “spatial relation”, a “spatial domain filter”, “transmission power”, “phase rotation”, an “antenna port”, an “antenna port group”, a “layer”, “the number of layers”, a “rank”, a “resource”, a “resource set”, a “resource group”, a “beam”, a “beam width”, a “beam angle”, an “antenna”, an “antenna element” and a “panel” can be interchangeably used.

In the present disclosure, terms such as a “Base Station (BS)”, a “radio base station”, a “fixed station”, a “NodeB”, an “eNodeB (eNB)”, a “gNodeB (gNB)”, an “access point”, a “Transmission Point (TP)”, a “Reception Point (RP)”, a “Transmission/Reception Point (TRP)”, a a “cell”, a “sector”, a “cell group”, a “carrier” and a “component carrier” can be interchangeably used. The base station is also referred to as terms such as a macro cell, a small cell, a femtocell or a picocell.

The base station can accommodate one or a plurality of (e.g., three) cells. When the base station accommodates a plurality of cells, an entire coverage area of the base station can be partitioned into a plurality of smaller areas. Each smaller area can also provide a communication service via a base station subsystem (e.g., indoor small base station (RRH: Remote Radio Head)). The term “cell” or “sector” indicates part or the entirety of the coverage area of at least one of the base station and the base station subsystem that provide a communication service in this coverage.

In the present disclosure, the terms such as “Mobile Station (MS)”, “user terminal”, “user apparatus (UE: User Equipment)” and “terminal” can be interchangeably used.

The mobile station is also referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or some other appropriate terms in some cases.

At least one of the base station and the mobile station may be referred to as, for example, a transmission apparatus, a reception apparatus or a radio communication apparatus. In addition, at least one of the base station and the mobile station may be, for example, a device mounted on a movable body or the movable body itself. The movable body may be a vehicle (e.g., a car or an airplane), may be a movable body (e.g., a drone or a self-driving car) that moves unmanned or may be a robot (a manned type or an unmanned type). In addition, at least one of the base station and the mobile station includes an apparatus, too, that does not necessarily move during a communication operation. For example, at least one of the base station and the mobile station may be an Internet of Things (IoT) device such as a sensor.

Furthermore, the base station in the present disclosure may be read as the user terminal. For example, each aspect/embodiment of the present disclosure may be applied to a configuration where communication between the base station and the user terminal is replaced with communication between a plurality of user terminals (that may be referred to as, for example, Device-to-Device (D2D) or Vehicle-to-Everything (V2X)). In this case, the user terminal 20 may be configured to include the functions of the above-described base station 10. Furthermore, words such as “uplink” and “downlink” may be read as a word (e.g., a “side”) that matches terminal-to-terminal communication. For example, the uplink channel and the downlink channel may be read as side channels.

Similarly, the user terminal in the present disclosure may be read as the base station. In this case, the base station 10 may be configured to include the functions of the above-described user terminal 20.

In the present disclosure, operations performed by the base station are performed by an upper node of this base station depending on cases. Obviously, in a network including one or a plurality of network nodes including the base stations, various operations performed to communicate with a terminal can be performed by base stations, one or more network nodes (that are regarded as, for example, Mobility Management Entities (MMEs) or Serving-Gateways (S-GWs), yet are not limited to these) other than the base stations or a combination of these.

Each aspect/embodiment described in the present disclosure may be used alone, may be used in combination or may be switched and used when carried out. Furthermore, orders of the processing procedures, the sequences and the flowchart according to each aspect/embodiment described in the present disclosure may be rearranged unless contradictions arise. For example, the method described in the present disclosure presents various step elements by using an exemplary order and is not limited to the presented specific order.

Each aspect/embodiment described in the present disclosure may be applied to Long Term Evolution (LTE), LTE-Advanced (LTE-A), LTE-Beyond (LTE-B), SUPER 3G, IMT-Advanced, the 4th generation mobile communication system (4G), the 5th generation mobile communication system (5G), Future Radio Access (FRA), the New-Radio Access Technology (RAT), New Radio (NR), New radio access (NX), Future generation radio access (FX), Global System for Mobile communications (GSM) (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other appropriate radio communication methods, or next-generation systems that are enhanced based on these systems. Furthermore, a plurality of systems may be combined (for example, LTE or LTE-A and 5G may be combined) and applied.

The phrase “based on” used in the present disclosure does not mean “based only on” unless specified otherwise. In other words, the phrase “based on” means both of “based only on” and “based at least on”.

Every reference to elements that use names such as “first” and “second” used in the present disclosure does not generally limit the quantity or the order of these elements. These names can be used in the present disclosure as a convenient method for distinguishing between two or more elements. Hence, the reference to the first and second elements does not mean that only two elements can be employed or the first element should precede the second element in some way.

The term “deciding (determining)” used in the present disclosure includes diverse operations in some cases. For example, “deciding (determining)” may be considered to “decide (determine)” judging, calculating, computing, processing, deriving, investigating, looking up, search and inquiry (e.g., looking up in a table, a database or another data structure), and ascertaining.

Furthermore, “deciding (determining)” may be considered to “decide (determine)” receiving (e.g., receiving information), transmitting (e.g., transmitting information), input, output and accessing (e.g., accessing data in a memory).

Furthermore, “deciding (determining)” may be considered to “decide (determine)” resolving, selecting, choosing, establishing and comparing. That is, “deciding (determining)” may be considered to “decide (determine)” some operation.

Furthermore, “deciding (determining)” may be read as “assuming”, “expecting” and “considering”.

“Maximum transmit power” disclosed in the present disclosure may mean a maximum value of transmit power, may mean the nominal UE maximum transmit power, or may mean the rated UE, maximum transmit power.

The words “connected” and “coupled” used in the present disclosure or every modification of these words can mean every direct or indirect connection or coupling between 2 or more elements, and can include that 1 or more intermediate elements exist between the two elements “connected” or “coupled” with each other. The elements may be coupled or connected physically or logically or by a combination of these physical and logical connections. For example, “connection” may be read as “access”.

It can be understood in the present disclosure that, when connected, the two elements are “connected” or “coupled” with each other by using 1 or more electric wires, cables or printed electrical connection, and by using electromagnetic energy having wavelengths in radio frequency domains, microwave domains or (both of visible and invisible) light domains in some non-restrictive and non-comprehensive examples.

A sentence that “A and B are different” in the present disclosure may mean that “A and B are different from each other”. In this regard, the sentence may mean that “A and B are each different from C”. Words such as “separate” and “coupled” may be also interpreted in a similar way to “different”.

When the words “include” and “including” and modifications of these words are used in the present disclosure, these words intend to be comprehensive similar to the word “comprising”. Furthermore, the word “or” used in the present disclosure intends to not be an exclusive OR.

When, for example, translation adds articles such as a, an and the in English in the present disclosure, the present disclosure may include that nouns coming after these articles are plural.

The invention according to the present disclosure has been described in detail above. However, it is obvious for a person skilled in the art that the invention according to the present disclosure is not limited to the embodiment described in the present disclosure. The invention according to the present disclosure can be carried out as modified and changed aspects without departing from the gist and the scope of the invention defined based on the recitation of the claims. Accordingly, the description of the present disclosure is intended for exemplary explanation, and does not bring any restrictive meaning to the invention according to the present disclosure.

1. A user terminal comprising:
a control section that controls monitoring of one search space set or a plurality of search space sets associated with a plurality of control resource sets; and
a receiving section that receives downlink control information that is mapped on a downlink control channel candidate included in the one search space set or a plurality of downlink control channel candidates respectively included in the plurality of search space sets.

2. The user terminal according to claim 1, wherein a plurality of portion domains are respectively associated with the plurality of control resource sets, the plurality of portion domains being obtained by splitting the downlink control channel candidate included in the one search space set.

3. The user terminal according to claim 1, wherein the receiving section receives a list that indicates the plurality of control resource sets associated with the one search space set.

4. The user terminal according to claim 1, wherein the plurality of search space sets on which the downlink control information is mapped are respectively associated with the plurality of control resource sets.

5. The user terminal according to claim 1, in wherein the receiving section receives a list that indicates the plurality of search space sets on which the downlink control information is mapped.

6. A radio communication method of a user terminal comprising:
controlling monitoring of one search space set or a plurality of search space sets associated with a plurality of control resource sets; and
receiving downlink control information that is mapped on a downlink control channel candidate included in the one search space set or a plurality of downlink control channel candidates respectively included in the plurality of search space sets.

7. The user terminal according to claim 2, wherein the receiving section receives a list that indicates the plurality of control resource sets associated with the one search space set.

8. The user terminal according to claim 4, wherein the receiving section receives a list that indicates the plurality of search space sets on which the downlink control information is mapped.
